(19) United States
(12) Patent Application Publication
(10) Pub. No.: US 2009/0201274 A1
(43) Pub. Date: Aug. 13, 2009

(54) Timing Signal Generating Circuit, Electronic Apparatus, Display Apparatus, Image-Reception Apparatus, and Driving Method

(75) Inventors: Nobuhiro Kuwabara, Mie (JP); Tomoyuki Nagai, Mie (JP); Tamotsu Sakai, Nara (JP); Kazuhiro Maeda, Kyoto (JP); Shuji Nishi, Nara (JP); Masakazu Satoh, Nara (JP)

Correspondence Address: HARNESS, DICKEY & PIERCE, P.L.C., P.O. BOX 8910, RESTON, VA, 20195, US

(73) Assignee: SHARP KABUSHIKI KAISHA, Osaka (JP)

(21) Appl. No.: 11/664,084

(22) PCT Filed: Sep. 28, 2005
(86) PCT No.: PCT/JP05/17895

§ 371 Date: Oct. 2, 2008

(30) Foreign Application Priority Data
Sep. 30, 2004 (JP) 2004-288566

(51) Int. Cl. G09G 5/00

(52) U.S. Cl. 345/208

(57) ABSTRACT

A timing signal generating device for a matrix-type display apparatus is disclosed, conducive to reduction of power consumption, the matrix-type display apparatus including the timing signal generating device, and a driving method thereof. In at least one embodiment, a timing signal generating apparatus provided in an active-matrix liquid crystal display apparatus includes a horizontal direction counter and a vertical direction counter for counting a clock number; and a horizontal counter cessation circuit and a vertical counter cessation circuit for stopping the horizontal direction counter and the vertical direction counter at a predetermined timing. With this structure, at least one embodiment of the present invention achieves reduction in power consumption in the liquid crystal display apparatus.

### TECHNICAL FIELD

The present invention relates to a timing signal generating apparatus, an electronic apparatus and a display apparatus, and a driving method for an electronic apparatus, particularly to a timing signal generating apparatus conducive to reduction of power consumption, an electronic apparatus including the timing signal generating apparatus, and driving methods for the display apparatus and the electronic apparatus.

### BACKGROUND ART

A matrix-type display apparatus with pixels aligned in a matrix has conventionally been used as a display apparatus including display pixels aligned in an array manner as electronic elements, and a drive circuit for driving the pixels. An active-matrix liquid crystal display apparatus is a typical example of the matrix-type display apparatus.

FIG. 4 is a schematic view showing a diagrammatic structure of a conventional active-matrix liquid crystal display apparatus.

as shown in the figure, a liquid crystal display apparatus 500 includes a liquid-crystal display panel 501, a source driver 502, a gate driver 503, and a liquid-crystal display control circuit 504.

The liquid-crystal display panel 501 is constituted of a substrate thereon having display pixel electrodes and TFT transistors for applying voltages to the display pixel electrodes. They are both aligned in a matrix. The source driver 502 is disposed on the upper side of the liquid-crystal display panel 501, and the gate driver 503 is disposed on the left side of the liquid-crystal display panel 501. A unit of display data corresponding to 1 horizontal line is latched by the source driver 502, and is subjected to D/A conversion, and the resulting gradation voltages are sequentially written to each horizontal line of pixel electrodes of the liquid-crystal display panel 501 from upper to lower order. The voltage for the corresponding pixel is applied between the pixel electrode and the common pixel electrode, and the transmittance of liquid crystal for each electrode is controlled according to the applied voltages, so that an image corresponding to the display data is displayed.

The liquid-crystal display control circuit 504 generates various timing signals for image display so as to control the source driver 502, the gate driver 503, and drive the liquid-crystal display panel 501. The liquid-crystal display control circuit 504 includes a timing signal generating circuit 300 for generating the various timing signals.

FIG. 5 is a circuit block diagram schematically showing a structure of the timing signal generating circuit 300. As shown in the figure, the timing signal generating circuit 300 includes a counter initialization circuit 31, a horizontal direction counter 32, a vertical direction counter 33, and a signal generating circuit group 34.

The counter initialization circuit 31 is supplied with a horizontal reference signal (HSYNC signal, hereinafter), a vertical reference signal (VSYNC signal, hereinafter), and a clock signal (CLK signal, hereinafter) and outputs a control signal to the horizontal direction counter 32 and the vertical direction counter 33. The horizontal direction counter 32 is supplied with a CLK signal, and counts the clock number so as to supply the clock number to a horizontal decoder (not shown) of the signal generating circuit group 34. Further, the horizontal direction counter 32 is structured to reset the counter at the time where it receives a control signal, which is synchronized with the HSYNC signal, from the counter initialization circuit 31. The vertical direction counter 33 is supplied with a CLK signal and a HSYNC signal, and counts a HSYNC signal pulse number in synchronism with a CLK signal, and transmits the count value to a vertical decoder (not shown) of the signal generating circuit group 34. Further, the vertical direction counter 33 is structured to reset the counter at the time where it receives a control signal, which is synchronized with the VSYNC signal, from the counter initialization circuit 31. More specifically, the control signal supplied from the counter initialization circuit 31 functions as a counter reset signal.

The signal generating circuit group 34 includes a plurality of signal generating circuits for generating various timing signals for driving a liquid crystal display apparatus. Specifically, a SSP circuit 34a for generating a shift-start signal (SSP signal, hereinafter) of a source driver 502, a GSP circuit 34b for generating a busline selecting start signal (GSP signal, hereinafter) of a gate driver 503, a GCK circuit 34c for generating a busline selecting signal shift clock signal (GCK signal, hereinafter) of a gate driver 503, a FRP circuit 34d for generating a polarity selecting signal (FRP signal, hereinafter) used as a base signal for polarity inversion or the like of COM signals and image signals, a LR circuit 34e for generating a scanning direction switching signal (LR signal, hereinafter) of the source driver 502, a PWC circuit 34f for generating a busline selecting signal width control signal (PWC signal, hereinafter) of the gate driver 503, a PCTL circuit 34g for generating a precharge control signal (PCTL signal, hereinafter), and a UD circuit 34h for generating a scanning direction switching signal (UD signal, hereinafter) of the gate driver 503.

FIG. 6(a) and FIG. 6(b) show timing charts of the foregoing timing signal generating apparatus. FIG. 6(a) shows a timing chart in the horizontal direction, and FIG. 6(b) shows a timing chart in the vertical direction.

First, the following explains a timing chart in the horizontal direction. The timing chart in the horizontal direction of FIG. 6(a) shows performance periods of the HSYNC signal, the SSP signal, the LR signal, the GCK signal, the PWC signal, the PCTL signal, the FRP signal, and the horizontal direction counter 32.

As shown in the figure, the SSP signal is structured to have a change point immediately after a HSYNC signal of “Low” becomes “High”. Further, the LR signal, the GCK signal, the PWC signal, the PCTL signal, and the FRP signal are each structured to have a change after a HSYNC signal of “Low” becomes “High” and immediately before the next HSYNC signal turns from “High” to “Low”.

A period starting from when the HSYNC signal becomes “Low” and then becomes “High”, until the next HSYNC signal becomes “Low” and then becomes “High”, in other words, a single horizontal scanning period T91 of an image signal is constituted of a horizontal effective display period T92 (horizontal effective display region) during which image signals including image information are outputted, and a horizontal blanking period. A general horizontal effective display period T92 starts from output of a change point of SSP to the end of horizontal scanning, and a general horizontal blanking period starts from an arbitrary horizontal effective display period T92 to the next horizontal effective display period T92. The various timing signals: LR signal, GCK signal, PWC signal, PCTL signal, and FRP signal are each structured to have a change point during the horizontal blanking period.

The horizontal direction counter 32 needs to count the clock number to the point required by the signals outputted from the signal generating circuit group 34 (generally to the point of change). Therefore, the horizontal direction counter 32 needs to continuously count the clock number during the whole period between the change of the HSYNC signal from “Low” to “High” and the change of the next HSYNC signal from “Low” to “High”, in other words, during the entire 1 horizontal scanning period T91.

That is, the horizontal direction counter 32 keeps counting the clock number during the entire 1 horizontal scanning period T91.

Next, the following explains a timing chart in the vertical direction. The timing chart in the vertical direction of FIG. 6(b) shows performance periods of the VSYNC signal, the HSYNC signal, the SSP signal, the GCK signal, the PWC signal, the GSP signal, the PCTL signal, the UD signal, the vertical effective display period T95 (vertical effective display region), the vertical blanking period T96, and the vertical direction counter 33.

In this timing chart, a period between the change of the VSYNC signal from “Low” to “High” and the change of the next VSYNC signal from “Low” to “High” again, in other words, a single vertical scanning period T94 is constituted of the vertical effective display period T95 (vertical effective display region) and the vertical blanking period T96, which starts from output of a horizontal image signal from the final stage to supply of a horizontal image signal to the first stage of the next vertical scanning period T94.

The various signals such as the SSP signals are usually stopped in the vertical blanking period T96 for reduction of power consumption. Therefore, as shown in FIG. 6(b), the SSP signal, the GCK signal, the PWC signal, and the PCTL signal are each structured to have a change point during the vertical effective display period T95. Further, the GSP signal is structured to have a change point immediately after a change of VSYNC signal from “Low” to “High”. The UD signal is structured to have a change point after the VSYNC becomes “Low” and then becomes “High” immediately before the next VSYNC signal becomes “Low” and then becomes “High”.

To find out the starting point of the vertical blanking period T96, the vertical direction counter 33 needs to carry on the counting at least during the vertical effective display period T95, and also during the vertical blanking period T96 most of the cases. Therefore, the vertical direction counter 33 is also set to carry on the counting in the period between the change of VSYNC signal from “Low” to “High” to a change of the next VSYNC signal from “Low” to “High”, that is, during a single vertical scanning period T94, as with the horizontal direction counter 32. More specifically, the vertical direction counter 33 carries on counting during a single vertical scanning period T94.

In recent years, a display apparatus is mounted to various apparatuses such as computers, OA apparatuses, mobile terminals etc. Therefore, indispensable objectives in designing a display apparatus are reduction of power consumption and miniaturization. Particularly, the active-matrix liquid crystal display apparatus has been developed to reduce power consumption of the liquid crystal display control apparatus (drive circuit; described above).

For example, Japanese Unexamined Patent Publication Tokukaihei 8-305316 (published on Nov. 22, 1996; hereinafter referred to as Patent Document 1) teaches a technique for realizing great power reduction in a drive circuit of an image display apparatus which consumes great power with a structure in which a pixel array and a drive circuit are both formed monolithically on a polycrystalline silicon thin film. This prior art suspends signal supply to the drive circuit or to the data signal line in synchronism with the vertical and horizontal blanking periods included in an image signal.

Further, though it is not aimed at direct reduction in power consumption, Japanese Unexamined Patent Publication Tokukaihei 10-11033 (published on Jan. 16, 1998; hereinafter referred to as Patent Document 2) teaches a liquid crystal display apparatus and a driving method thereof, which are arranged to prevent supply of DC components to a liquid crystal panel at the time of power-on. This is achieved with provision of signal suspending means between a timing generator and a liquid-crystal panel. The signal suspending means suspends at least one of a vertical start pulse or a horizontal start pulse sequentially supplied to a vertical scanner or a horizontal scanner until the image signals outputted from the video driver become stable at the time of power-on. In this way, writing of unstable image signals to the liquid crystal pixels can be prevented.

As described, the structure of the conventional timing signal generating circuit 300 requires the horizontal direction counter 32 to continuously count the clock number during 1 horizontal scanning period, and also requires the vertical direction counter 33 to continuously count the clock number during 1 vertical scanning period. Therefore, the conventional timing signal generating circuit 300 has a problem of large power consumption.

However, no technique has been suggested to reduce power consumed by the counters of the timing signal generating circuit 300. For example, the foregoing Patent Document 1 teaches a technique of reducing power consumption by stopping signal supply in the blanking period, and Patent Document 2 teaches a technique of stopping supply of start pulse at the predetermined time, but neither of them disclose nor suggest a technique of suppressing power consumed by the counter of the timing signal generating circuit 300.

Therefore, the inventors of the present invention regards that it is necessary to develop a technique of reducing power consumed by the counter of a timing signal generating circuit in a liquid crystal display control apparatus. Moreover, since the timing signal generating apparatus is always required for a general matrix-type display apparatus, the unsolved problem concerns all of the matrix-type display apparatuses.

The present invention was made in view of the foregoing conventional problem, and an object is to provide timing signal generating means consuming less power for a matrix-type display apparatus; a matrix-type display apparatus including the timing signal generating means; and a driving method thereof.

### DISCLOSURE OF INVENTION

In order to solve the foregoing objective, a timing signal generating apparatus according to the present invention is at least supplied with a reference signal and outputs a timing signal to a drive circuit for driving electronic elements arranged in an array, the timing signal generating apparatus comprising: counter means for carrying out counting operation based on the reference signal; a signal generation circuit for generating the timing signal according to counter output of the counter means; and counter cessation means capable of stopping counting operation of the counter means during a period from input of an arbitrary reference signal to input of a next reference signal.

With this arrangement, the counting operation of the counter means is carried out only in the required period and then is stopped. Therefore, the operation of the counter means is suspended for a certain time period, which provides an effect of power saving.

In order to solve the foregoing objective, a timing signal generating apparatus according to the present invention is at least supplied with a clock signal and a horizontal reference signal and outputs a timing signal to a horizontal drive circuit for driving electronic elements arranged in a matrix, the timing signal generating apparatus comprising: horizontal direction counter means for carrying out counting operation of the clock signal based on the horizontal reference signal; a signal generation circuit for generating the timing signal according to counter output of the horizontal direction counter means; and horizontal counter cessation means capable of stopping counting operation of the horizontal direction counter means during a period from input of an arbitrary horizontal reference signal to input of a next horizontal reference signal.

With this arrangement, the counting operation of the horizontal direction counter means is carried out only in the required period and then is stopped. Therefore, the operation of the horizontal direction counter means is suspended for a certain time period, which provides an effect of power saving.

In order to solve the foregoing objective, a timing signal generating apparatus according to the present invention is at least supplied with a horizontal reference signal and a vertical reference signal and outputs a timing signal to a vertical drive circuit for driving electronic elements arranged in a matrix, the timing signal generating apparatus comprising: vertical direction counter means for counting a pulse number of the horizontal reference signal based on the vertical reference signal; a signal generation circuit for generating the timing signal according to counter output of the vertical direction counter means; and vertical counter cessation means capable of stopping counting operation of the vertical counter means during a period from input of an arbitrary vertical reference signal to input of a next vertical reference signal.

With this arrangement, the counting operation of the vertical direction counter means is carried out only in the required period and then is stopped. Therefore, the operation of the vertical direction counter means is suspended for a certain time period, which provides an effect of power saving.

In order to solve the foregoing objective, a timing signal generating apparatus according to the present invention is at least supplied with a horizontal reference signal, a vertical reference signal, and a clock signal and outputs a timing signal to a horizontal and vertical drive circuit for driving electronic elements arranged in a matrix, the timing signal generating apparatus comprising: horizontal direction counter means for counting a clock number of the clock signal based on the horizontal reference signal;

vertical direction counter means for counting a pulse number of the horizontal reference signal based on the vertical reference signal; a signal generation circuit for generating the timing signal according to counter outputs of the horizontal direction counter means and the vertical direction counter means; the timing signal generating apparatus further comprising: horizontal counter cessation means capable of stopping counting operation of the horizontal direction counter means during a period from input of an arbitrary horizontal reference signal to input of a next horizontal reference signal; and vertical counter cessation means capable of stopping counting operation of the vertical direction counter means during a period from input of an arbitrary vertical reference signal to input of a next vertical reference signal.

With this arrangement, the counting operations of the horizontal and vertical direction counter means are carried out only in the required period and then are stopped. Therefore, the operations of the horizontal and vertical direction counter means are suspended for a certain time period, which provides an effect of power saving.

In order to solve the foregoing objective, a timing signal generating apparatus according to the present invention is at least supplied with a clock signal and a vertical reference signal and outputs a timing signal to a drive circuit for driving electronic elements arranged in a matrix, the timing signal generating apparatus comprising: vertical counter means for counting a clock number of the clock signal based on the vertical reference signal; a signal generation circuit for generating the timing signal according to counter output of the vertical counter means; and

vertical counter cessation means capable of stopping counting operation of the vertical counter means during a period from input of an arbitrary reference signal to input of a next reference signal.

With this arrangement, the counting operation of the vertical direction counter means is carried out only in the required period and then is stopped. Therefore, the operation of the vertical direction counter means is suspended for a certain time period, which provides an effect of power saving.

The timing signal generating apparatus according to the present invention preferably further comprises: a control section which starts the counting operation of the horizontal direction counter means in response to input of the horizontal reference signal, generates a change point of the timing signal, and causes the horizontal counter cessation means to stop the counting operation of the horizontal direction counter means, the counting operation being suspended until a next horizontal reference signal is supplied.

With this arrangement, the signal generation circuit group generates a change of the timing signal during the counting operation of the horizontal direction counter means. Therefore, it is possible to securely carry on the counting of clock number to the point required by the signals outputted from the signal generating circuit group (generally to the change point).

Further, the timing signal generating apparatus according to the present invention preferably further comprises: a control section which starts the counting operation of the vertical direction counter means in response to input of the vertical reference signal, generates a change point of the timing signal, and causes the vertical counter cessation means to stop the counting operation of the vertical direction counter means, the counting operation being suspended until a next vertical reference signal is supplied.

With this arrangement, the counting of the vertical direction counter means is stopped after generation of a change of the timing signal.

Generally, the effective display region begins after the change of the timing signal. The vertical direction counter means is required to keep on counting until the start point of the effective display region is found, but once the start is found the counting is no longer required. Therefore, with the foregoing arrangement, the power consumption thereafter can be reduced.

The timing signal generating apparatus according to the present invention is preferably arranged so that the electronic elements arranged in a matrix are display pixels arranged in a matrix, and the signal generation circuit generates change points of all timing signals produced in 1 horizontal scanning period of an image signal, during the counting operation of the horizontal direction counter means.

With this arrangement, the signal generation circuit group generates a change of the timing signal during the counting operation of the horizontal direction counter means. Therefore, it is possible to securely carry on the counting of clock number to the point required by the signals outputted from the signal generating circuit group (generally to the change point).

The timing signal generating apparatus according to the present invention is preferably arranged so that the electronic elements arranged in a matrix are display pixels arranged in a matrix, and the horizontal counter cessation means suspends the counting operation of the horizontal direction counter means so that the suspension period resides in a period from the change points of all timing signals produced from the signal generating circuit to input of a new horizontal reference signal within 1 horizontal scanning period of an image signal which starts in response to input of an arbitrary horizontal reference signal.

With this arrangement, the signal generation circuit group generates a change of the timing signal during the counting operation of the horizontal direction counter means. Therefore, it is possible to securely carry on the counting of clock number to the point required by the signals outputted from the signal generating circuit group (generally to the change point).

The timing signal generating apparatus according to the present invention is preferably arranged so that the electronic elements arranged in a matrix are display pixels arranged in a matrix, and the vertical counter cessation means suspends the counting operation of the vertical direction counter means so that the suspension period resides in a period from the change points of all timing signals produced from the signal generating circuit to input of a new vertical reference signal within 1 vertical scanning period of an image signal which starts in response to input of an arbitrary vertical reference signal.

With this arrangement, the counting of the vertical direction counter means is stopped after generation of a change of the timing signal.

Generally, the effective display region begins after the change of the timing signal. The vertical direction counter means is required to keep on counting until the start point of the effective display region is found, but once the start is found the counting is no longer required. Therefore, with the foregoing arrangement, the power consumption thereafter can be reduced.

The timing signal generating apparatus according to the present invention is preferably arranged so that the electronic elements arranged in a matrix are display pixels arranged in a matrix, and the signal generating circuit at least includes a circuit for generating a shift start signal of the horizontal drive circuit and generates a plurality of timing signals, the shift start signal of the horizontal drive circuit is structured to have a change point at a latest timing among all timing signals produced from the signal generating circuit during 1 horizontal scanning period of an image signal which starts in response to input of an arbitrary horizontal reference signal, and the horizontal counter cessation means suspends the counting operation of the horizontal direction counter means so that the suspension period resides in a period from a change point of a shift start signal of a source drive circuit which is produced from the signal generating circuit after the input of an arbitrary horizontal reference signal, to input of a new horizontal reference signal.

With this arrangement, the counting of the vertical direction counter means is stopped after generation of a change of the SSP signal.

Generally, the effective display region begins after the change of the SSP signal, and the changes of the timing signals are no longer generated.
Therefore, the counting is not necessary after the SSP signal. with the foregoing arrangement, the power consumption thereafter can be reduced.

The timing signal generating apparatus according to the present invention is preferably arranged so that the electronic elements arranged in a matrix are display pixels arranged in a matrix, and the signal generating circuit at least includes a circuit for generating a shift start signal of the vertical drive circuit and generates a plurality of timing signals, and

the vertical counter cessation means suspends the counting operation of the vertical direction counter means so that the suspension period resides in a period from a change point of the shift start signal of the vertical drive circuit, which is produced from the signal generating circuit after input of an arbitrary vertical reference signal, to input of a new horizontal reference signal.

With this arrangement, the counting of the vertical direction counter means is stopped after generation of a change of the GSP signal.

Generally, the effective display region begins after the change of the GSP signal. The vertical direction counter means is required to keep on counting until the start point of the effective display region is found, but once the start is found changes of those timing signals are no longer required.
Therefore, with the foregoing arrangement, the power consumption thereafter can be reduced.

The timing signal generating apparatus according to the present invention is preferably arranged so that the electronic elements arranged in a matrix are display pixels arranged in a matrix, and the timing signal generating apparatus is arranged so that a horizontal blanking period of an image signal begins in response to input of an arbitrary horizontal reference signal, and a subsequent horizontal effective display period continues until a next horizontal reference signal is supplied, and the horizontal counter cessation means controls the horizontal direction counter means so that the horizontal direction counter means carries out the counting operation at least in the horizontal blanking period and then suspends the counting operation for a certain period until a next horizontal reference signal is supplied.

With this arrangement, the signal generation circuit generates a change for each of the timing signals, which are produced in 1 horizontal scanning period, within the horizontal blanking period which starts in response to input of the horizontal reference signal. In this case, the horizontal direction counter means carries out counting at least in the horizontal blanking period, and then stops the counting at a predetermined timing. In this way, the counting is securely carried on until a change of the signal outputted from the signal generation circuit is generated, and is stopped thereafter. The power consumption can be thus reduced.

The timing signal generating apparatus according to the present invention is preferably arranged so that the electronic elements arranged in a matrix are display pixels arranged in a matrix, and the timing signal generating apparatus is arranged so that a vertical blanking period of an image signal begins in response to input of an arbitrary vertical reference signal, and a subsequent vertical effective display period continues until a next vertical reference signal is supplied, and the vertical counter cessation means controls the vertical direction counter means so that the vertical direction counter means carries out the counting operation at least in the vertical blanking period and then suspends the counting operation for a certain period until a next vertical reference signal is supplied.

With this arrangement, the vertical direction counter means carries out counting at least in the vertical blanking period. the vertical direction counter means needs to carry on counting until the start point of the vertical effective display period (vertical effective display region) is found. To find the start point of the effective display period (vertical effective display region), the vertical direction counter means needs to carry on counting at least in the vertical blanking period. Therefore, the vertical direction counter means is stopped at an arbitrary point after the end of vertical blanking period. With this cessation, the power consumption is reduced.

In order to solve the foregoing objective, a timing signal generating apparatus according to the present invention is preferably arranged so that the electronic elements arranged in a matrix are display pixels arranged in a matrix, and the timing signal generating apparatus is arranged so that a horizontal blanking period of an image signal begins in response to input of an arbitrary horizontal reference signal, and a subsequent horizontal effective display period continues until a next horizontal reference signal is supplied, and the horizontal counter cessation means controls the horizontal direction counter means so that the horizontal direction counter means carries out the counting operation only in the horizontal blanking period and then suspends the counting operation until a next horizontal reference signal is supplied.

With this arrangement, the horizontal direction counter means carries out counting only in the horizontal blanking period. The horizontal direction counter means is stopped at an arbitrary point after the end of the horizontal blanking period. With this cessation, the power consumption is reduced. In this case, the horizontal direction counter means serves to find the start point of horizontal effective display.

The timing signal generating apparatus according to the present invention is preferably arranged so that the electronic elements arranged in a matrix are display pixels arranged in a matrix, and the timing, signal generating apparatus is arranged so that a horizontal blanking period of an image signal begins in response to input of an arbitrary horizontal reference signal, and a subsequent horizontal effective display period continues until a next horizontal reference signal is supplied, and the horizontal counter cessation means controls the horizontal direction counter means so that the horizontal direction counter means carries out the counting operation only in the horizontal blanking period and then suspends the counting operation until a next horizontal reference signal is supplied.

With this arrangement, the vertical direction counter means carries out counting only in the vertical blanking period. Since the counting is stopped at a predetermined point after the end of the vertical blanking period, power consumption is reduced.

In order to solve the foregoing objective, a timing signal generating apparatus according to the present invention is at least supplied with a reference signal and outputs a signal to a drive circuit for driving electronic elements arranged in an array, the timing signal generating apparatus comprising: counter means for carrying out counting operation based on the reference signal; and a signal generation circuit for generating the timing signal according to counter output of the counter means, a bit number of the counter means being less than a bit number for expressing a binary number converted from a division result of 1 period of the reference signal by a period of a signal counted by the counter means.

With this arrangement, the bit number of the horizontal direction counter means is reduced, whereby the circuit scale is reduced. This provides effects of power saving and reduction in circuit area. Moreover, the quantity of wiring for connecting the horizontal direction counter means to the signal generation circuit is also reduced, and the circuit area (frame area) is further reduced.

In order to solve the foregoing objective, a timing signal generating apparatus according to the present invention is at least supplied with a reference signal and outputs a timing signal to a drive circuit for driving electronic elements arranged in a matrix, the timing signal generating apparatus comprising: counter means for carrying out counting operation based on the reference signal; and a signal generation circuit for generating the timing signal according to counter output of the counter means, a bit number of the counter means being less than a bit number for expressing a binary number converted from a division result of 1 period of the reference signal by a period of a signal counted by the counter means.

With this arrangement, the bit number of the horizontal direction counter means is reduced, whereby the circuit scale is reduced. This provides effects of power saving and reduction in circuit area. Moreover, the quantity of wiring for connecting the horizontal direction counter means to the signal generation circuit is also reduced, and the circuit area (frame area) is further reduced.

The timing signal generating apparatus according to the present invention is preferably arranged so that the horizontal direction counter means is realized by a counter whose bit number is less than a bit number for expressing a binary number converted from a division result of 1 horizontal scanning period by a period of the clock signal.

With this arrangement, the bit number of the horizontal direction counter means is reduced, whereby the circuit scale is reduced. This provides effects of power saving and reduction in circuit area. Moreover, the quantity of wiring for connecting the horizontal direction counter means to the signal generation circuit is also reduced, and the circuit area (frame area) is further reduced.

The timing signal generating apparatus according to the present invention is preferably arranged so that the vertical direction counter means is realized by a counter whose bit number is less than a bit number for expressing a binary number converted from a division result of 1 vertical scanning period by a horizontal scanning period.

With this arrangement, the bit number of the horizontal direction counter means is reduced, whereby the circuit scale is reduced. This provides effects of power saving and reduction in circuit area. Moreover, the quantity of wiring for connecting the horizontal direction counter means to the signal generation circuit is also reduced, and the circuit area (frame area) is further reduced.

The timing signal generating apparatus according to the present invention is preferably arranged so that the vertical direction counter means is realized by a counter whose bit number is less than a bit number for expressing a binary number converted from a division result of 1 vertical scanning period by a period of the clock signal.

With this arrangement, the bit number of the horizontal direction counter means is reduced, whereby the circuit scale is reduced. This provides effects of power saving and reduction in circuit area. Moreover, the quantity of wiring for connecting the horizontal direction counter means to the signal generation circuit is also reduced, and the circuit area (frame area) is further reduced.

The timing signal generating apparatus according to the present invention is preferably arranged so that the electronic elements arranged in a matrix are display pixels arranged in a matrix, and the timing signal generating apparatus is arranged so that a horizontal blanking period of an image signal begins in response to input of an arbitrary horizontal reference signal, and a subsequent horizontal effective display period continues until a next horizontal reference signal is supplied, and the horizontal counter cessation means stops the counting operation of the horizontal direction counter means at a timing between an end of the horizontal blanking period and an end of counter of the horizontal direction counter means.

With this arrangement, the counting operation can be stopped in a simple and accurate manner.

The timing signal generating apparatus according to the present invention is preferably arranged so that the electronic elements arranged in a matrix are display pixels arranged in a matrix, and the timing signal generating apparatus is arranged so that a vertical blanking period of an image signal begins in response to input of an arbitrary vertical reference signal, and a subsequent vertical effective display period continues until a next vertical reference signal is supplied, and the vertical counter cessation means stops the counting operation of the vertical direction counter means at a timing between an end of the vertical blanking period and an end of counter of the vertical direction counter means.

With this arrangement, the counting operation can be stopped in a simple and accurate manner.

An electronic apparatus according to the present invention includes one of the foregoing timing signal generating apparatuses.

With this arrangement, the counter of the counter means is operated for a predetermined time period, and is stopped thereafter. Therefore, the operation of the counter means is suspended for a certain time period, which provides an effect of power saving.

A display apparatus according to the present invention includes one of the foregoing timing signal generating apparatuses.

With this arrangement, the counter of the counter means is operated for a predetermined time period, and is stopped thereafter. Therefore, the operation of the counter means is suspended for a certain time period, which provides an effect of power saving in the electronic apparatus.

The display apparatus according to the present invention is preferably arranged so that the timing signal generating apparatus is formed on a substrate monolithically with the image display elements.

An image-reception apparatus according to the present invention includes one of the foregoing timing signal generating apparatuses. The timing signal generating apparatus is formed on a substrate monolithically with the image display elements.

With this arrangement, the counter of the counter means is operated for a predetermined time period, and is stopped thereafter. Therefore, the operation of the counter means is suspended for a certain time period, which provides an effect of power saving in the image-reception apparatus.

In order to solve the foregoing objective, a driving method for an electronic apparatus according to the present invention is a method for driving an electronic apparatus comprising: electronic elements arranged in an array; a drive circuit for driving the electronic elements; and a timing signal generating apparatus which generates a timing signal and outputs the timing signal to the drive circuit based on a reference signal, the timing signal generating apparatus comprising: counter means for carrying out counting operation based on the reference signal; and a signal generation circuit for generating the timing signal according to counter output of the counter means, the method comprising the step of: suspending or finishing counting operation of the counter means during a period from input of an arbitrary reference signal to input of a next reference signal.

With this method, power consumption of the counter means in the electronic apparatus is reduced. Note that, “finish the counting” denotes output of a pulse for indicating the end of the counter when the counting comes to the end, so that the signal generation circuit stops referring to the counter.

In order to solve the foregoing objective, a driving method for an electronic apparatus according to the present invention is a method for driving an electronic apparatus comprising: electronic elements arranged in a matrix; a drive circuit for driving the electronic devices; and a timing signal generating apparatus which generates a timing signal and outputs the timing signal to the drive circuit based on a horizontal reference signal and a clock signal, the timing signal generating apparatus comprising: horizontal direction counter means for carrying out counting operation of a clock number of the clock signal based on the horizontal reference signal; and a signal generation circuit for generating the timing signal according to counter output of the horizontal direction counter means, the method comprising the step of: suspending or finishing counting operation of the horizontal direction counter means during a period from input of an arbitrary horizontal reference signal to input of a next horizontal reference signal.

With this method, power consumption of the counter means in the electronic apparatus is reduced. Note that, “finish the counting” denotes output of a pulse for indicating the end of the counter when the counting comes to the end, so that the signal generation circuit stops referring to the counter.

A driving method for an electronic apparatus according to the present invention is a method for driving an electronic apparatus comprising: electronic elements arranged in a matrix; a drive circuit for driving the electronic elements; and a timing signal generating apparatus which generates a timing signal and outputs the timing signal to the drive circuit based on a vertical reference signal and a horizontal reference signal, the timing signal generating apparatus comprising: vertical direction counter means for counting a pulse number of the horizontal reference signal based on the vertical reference signal; and a signal generation circuit for generating a plurality of timing signals according to counter output of the vertical direction counter means, the method comprising the step of: suspending or finishing counting operation of the vertical counter means during a period from input of an arbitrary vertical reference signal to input of a next vertical reference signal.

With this method, power consumption of the counter means in the electronic apparatus is reduced.

A driving method for an electronic apparatus according to the present invention is a method for driving an electronic apparatus comprising: electronic elements arranged in a matrix; vertical and horizontal drive circuits for driving the electronic elements; and a timing signal generating apparatus which generates a plurality of timing signals and outputs the timing signals to the vertical and horizontal drive circuits based on a horizontal reference signal and a vertical reference signal, the timing signal generating apparatus comprising: horizontal direction counter means for counting a clock number based on the horizontal reference signal; and

vertical direction counter means for counting a clock number based on the vertical reference signal, the method comprising the steps of: causing the horizontal direction counter means to start counting operation of a clock number upon input of the horizontal reference signal, and suspending or finishing counting operation of the horizontal direction counter means thereafter, the counting operation being suspended or finished until a next horizontal reference signal is supplied; and causing the vertical direction counter means to start counting operation of a clock number upon input of the vertical reference signal, and suspending or finishing counting operation of the vertical direction counter means thereafter, the counting operation being suspended or finished until a next vertical reference signal is supplied.

With this method, power consumption of the counter means in the electronic apparatus is reduced.

A driving method for an electronic apparatus according to the present invention is a method for driving an electronic apparatus comprising: electronic elements arranged in a matrix; a drive circuit for driving the electronic elements; and a timing signal generating apparatus which generates a plurality of timing signals and outputs the timing signals to the drive circuit based on a vertical reference signal and a clock signal, the timing signal generating apparatus comprising: counter means for counting a clock number of the clock signal based on the vertical reference signal; and a signal generation circuit for generating a plurality of timing signals according to counter output of the counter means, the method comprising the step of: suspending or finishing counting operation of counter means during a period from input of an arbitrary reference signal to input of a next reference signal.

With this method, power consumption of the counter means in the electronic apparatus is reduced.

A driving method for an electronic apparatus according to the present invention is a method for driving an electronic apparatus comprising:

electronic elements arranged in an array; a drive circuit for driving the electronic elements; and a timing signal generating apparatus which generates a timing signal and outputs the timing signal to the drive circuit based on a reference signal, the timing signal generating apparatus comprising:
counter means for carrying out counting operation based on the reference signal; and a signal generation circuit for generating the timing signal according to counter output of the counter means, the counter means is formed of a counter whose bit number is less than a bit number for expressing a binary number converted from a division result of 1 period of the reference signal by a period of the signal counted by the counter means, the method comprising the step of: outputting a control signal so that the signal generation circuit to stop referring to a signal number counted by the counter means at an end of counter of the counter means.

With this method, power consumption of the counter means in the electronic apparatus is reduced.

### BRIEF DESCRIPTION OF DRAWINGS

FIG. 1

A circuit block diagram schematically showing a structure of a timing signal generating apparatus (TG) according to one embodiment of the present invention.

FIG. 2(a)

A drawing showing a timing chart in the horizontal direction of a timing signal generating apparatus according to one embodiment of the present invention.

FIG. 2(b)

A drawing showing a timing chart in the vertical direction of a timing signal generating apparatus according to one embodiment of the present invention.

FIG. 3

A drawing showing an example of schematic structure of an active-matrix liquid crystal display apparatus according to one embodiment of the present invention.

FIG. 4

A drawing showing an example of schematic structure of a conventional active-matrix liquid crystal display apparatus.

FIG. 5

A circuit block diagram schematically showing a structure of a conventional timing signal generating apparatus.

FIG. 6(a)

A drawing showing a timing chart in the horizontal direction of a conventional timing signal generating apparatus.

FIG. 6(b)

A drawing showing a timing chart in the vertical direction of a conventional timing signal generating apparatus.

### BEST MODE FOR CARRYING OUT THE INVENTION

### First Embodiment

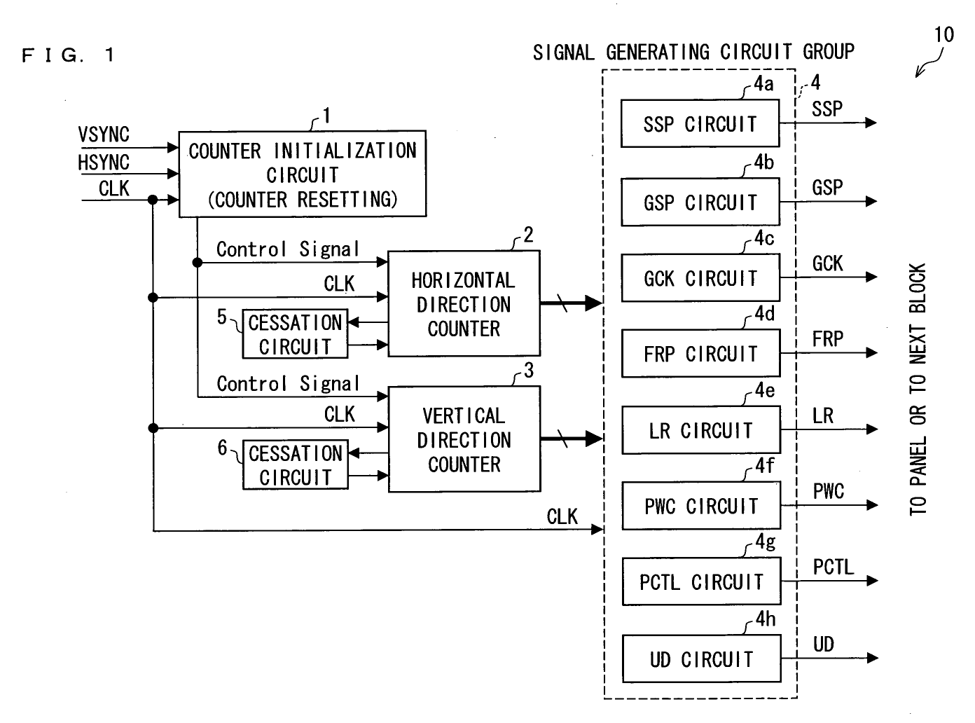

One embodiment of the present invention is described below with reference to FIG. 1 to FIG. 3.

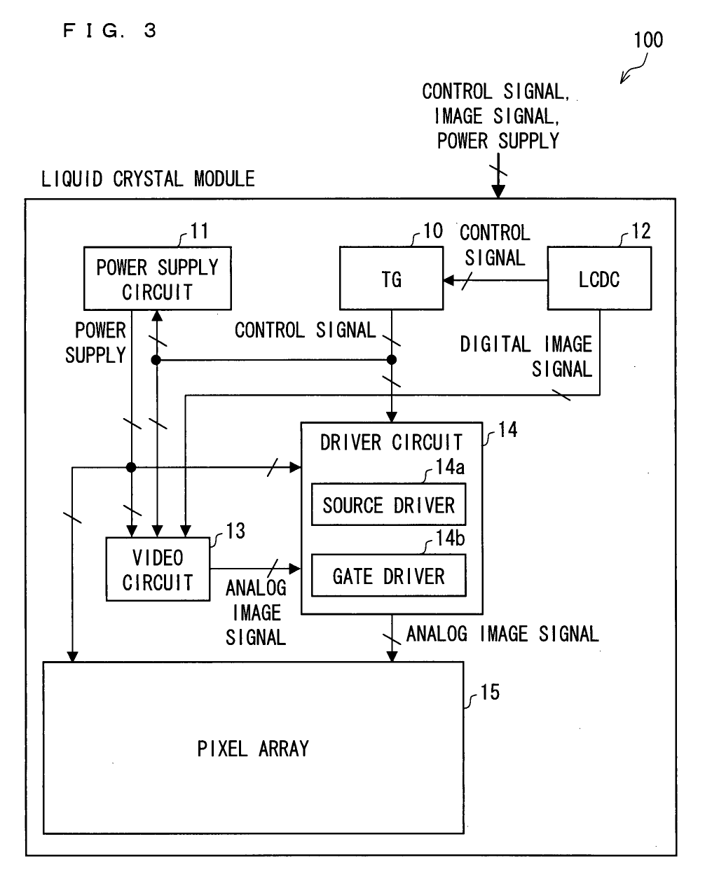

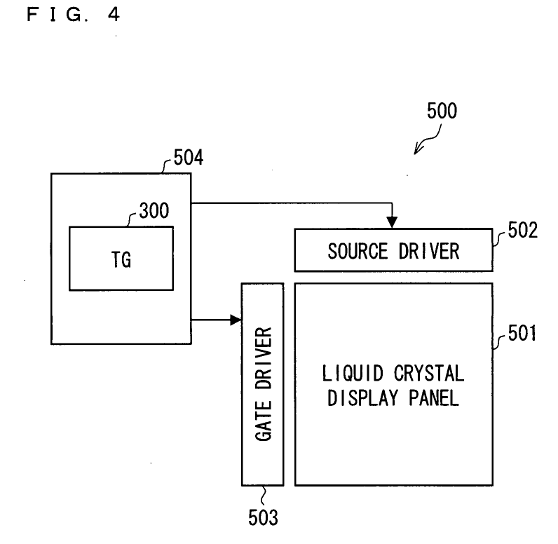

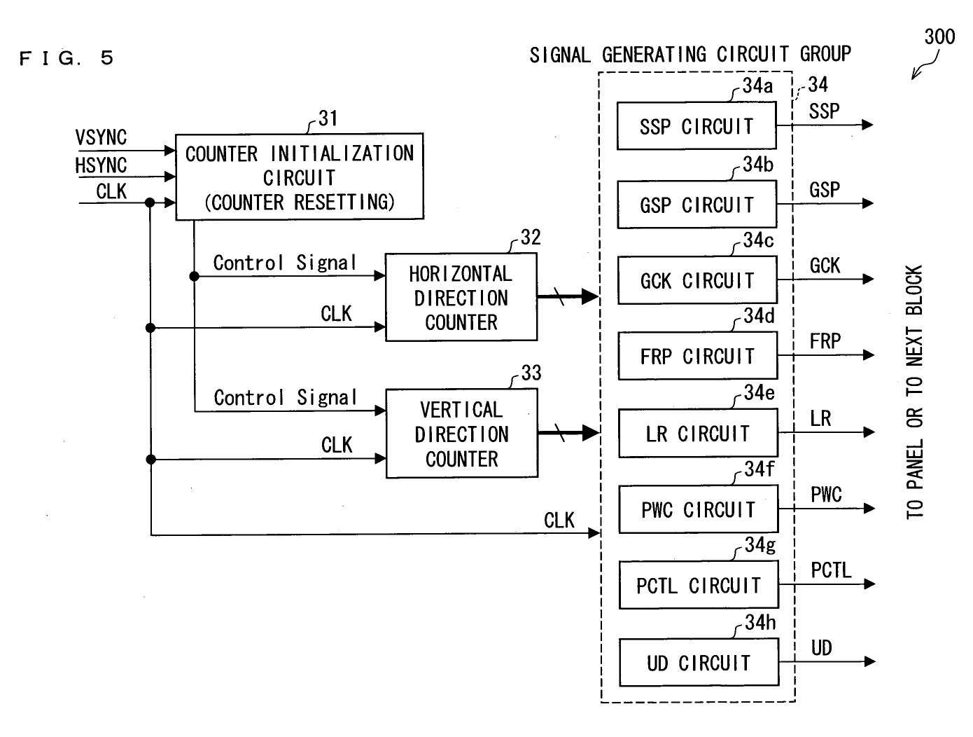

FIG. 3 shows an example of schematic structure of an active-matrix liquid crystal display apparatus according to one embodiment of the present invention. As shown in the figure, a liquid crystal display apparatus (liquid crystal module) 100 includes a timing signal generating apparatus (timing generator; “TG” hereinafter) 10, a power supply circuit 11, a liquid-crystal display control circuit (“LCDC”, hereinafter) 12, a video circuit 13, a driver circuit 14, and a pixel array 15.

The pixel array 15, serving as an image display element, is a liquid-crystal panel constituted of a substrate thereon having display pixel electrodes and TFT transistors for applying voltages to the display pixel electrodes. They are both aligned in a matrix on the substrate. The driver circuit 14 includes a source driver (horizontal drive circuit) 14a and a gate driver (vertical drive circuit) 14b.

In an example layout, the source driver 14a is disposed on an upper side of the pixel array 15, and the gate driver 14b is disposed on the left side of the pixel array 15. A unit of display data corresponding to 1 horizontal line is latched by the source driver 14a, and is subjected to D/A conversion, and the resulting gradation voltages are sequentially written to each horizontal line of pixel electrodes of the pixel array 15 from upper to lower order. The voltage for the corresponding pixel is applied between the pixel electrode and the common pixel electrode, and the transmittances of liquid crystal for each electrode are controlled according to the applied voltages, so that an image corresponding to the display data is displayed.

The power supply circuit 11 serves to supply power source to the video circuit 13, the driver circuit 14, and to the pixel array 15. The LCDC 12 outputs reference signals (horizontal reference signal (“HSYNC signal”, hereinafter) and the vertical reference signals (VSYNC signal, hereinafter)) and clock signals (“CLK signal”, hereinafter) to the TG 10, and also outputs digital image signals to the video circuit 13.

The TG 10 generates various timing signals based on the reference signals, and supplies the timing signals to the video circuit 13 or the driver circuit 14. The timing signals include a shift-start signal (“SSP signal”, hereinafter) of the source driver 14a, a scanning direction switching signal (“LR signal”, hereinafter) of the source driver 14a, a busline selecting signal shift clock signal (“GCK signal”, hereinafter) of the gate driver 14b, a busline selecting signal width control signal (“PWC signal”, hereinafter) of the gate driver 14b, a precharge control signal (“PCTL signal”, hereinafter), a polarity selecting signal (“FRP signal”, hereinafter), a busline selecting start signal (“GSP signal”, hereinafter) of the gate driver 14b, a scanning direction switching signal (“UD signal”, hereinafter) of the gate driver 14b. Note that, the FRP signal in this embodiment is used as a base signal for polarity inversion etc. of COM signal, and an image signal.

The video circuit 13 supplies analog image signals for driving liquid crystal to the driver circuit 14. The driver circuit 14 drives the pixel array 15 based on the signals from the TG 10 and the video circuit 13. More specifically, the gate driver 14b is driven by GSP to sequentially select the lines of liquid crystal pixels. The source driver 14a on the other hand is driven by SSP to distribute the image signals to the lines of liquid crystal pixels, and writes the corresponding signals to the liquid crystal pixels of the selected line. As a result, an image is displayed in the pixel array 15.

The following explains the TG 10, which is a distinctive feature of the present invention. The TG 10 is at least supplied with a horizontal reference signal, a vertical reference signal and a clock signal, and serves to function as a timing signal generating apparatus for generating and outputting timing signals to the horizontal drive circuit and the vertical drive circuit so as to drive display pixels aligned in a matrix. Though the present specification describes display pixels realized by liquid crystal display elements, the present invention is not limited to this type of pixels, and any matrix-type display pixels may be used. Note that, the horizontal reference signal and the vertical reference signal may be supplied from an external computer or the like.

FIG. 1 is a circuit block diagram schematically showing a structure of TG 10. As shown in FIG. 1, the TG 10 includes a counter initialization circuit 1, a horizontal direction counter 2, a vertical direction counter 3, a signal generating circuit group 4, a horizontal counter cessation circuit 5, and a vertical counter cessation circuit 6.

The counter initialization circuit 1 is supplied with a HSYNC signal, VSYNC signal, and a CLK signal, and outputs control signals to the horizontal direction counter 2, the vertical direction counter 3, the horizontal counter cessation circuit 5, and the vertical counter cessation circuit 6, respectively.

The horizontal direction counter 2 is supplied with a CLK signal, and counts the clock number so as to supply the clock number to a horizontal decoder (not shown) of the signal generating circuit group 4 and the horizontal counter cessation circuit 5. The horizontal direction counter 2 is structured to reset the counter at the time where it receives a control signal from the counter initialization circuit 1. More specifically, the control signal supplied from the counter initialization circuit 1 to the horizontal direction counter 2, which is synchronized with the HSYNC signal, functions as a counter reset signal. That is to say, the horizontal direction counter 2 functions as horizontal direction counting means for counting the clock number according to the HSYNC signal.

The vertical direction counter 3 is supplied with a CLK signal, and counts the clock number so as to supply the clock number to a vertical decoder (not shown) of the signal generating circuit group 4 and the vertical counter cessation circuit 6. The vertical direction counter 2 is structured to reset the counter at the time where it receives a control signal from the counter initialization circuit 1. More specifically, the control signal supplied from the counter initialization circuit 1 to the vertical direction counter 3, which is synchronized with the VSYNC signal, functions as a counter reset signal. That is to say, the vertical direction counter 3 functions as vertical direction counting means for counting the clock number according to the VSYNC signal.

The horizontal counter cessation circuit 5 serves as horizontal counter cessation means which controls the horizontal direction counter 2 so that the horizontal direction counter 2 starts counting of clock number at the time of input of a HSYNC signal, stop the counting at a predetermined timing, and suspend the counting until the next HSYNC signal is supplied. More specifically, the horizontal counter cessation circuit 5 is structured to stop the counting of the horizontal direction counter 2 at a predetermined timing according to the counter output of the horizontal direction counter 2. Note that, the predetermined timing at which the horizontal counter cessation circuit 5 stops the counting of the horizontal direction counter 2 is described later.

The vertical counter cessation circuit 6 serves as vertical counter cessation means which controls the vertical direction counter 3 so that the vertical direction counter 3 starts counting of clock number at the time of input of a VSYNC signal, stop the counting at a predetermined timing, and suspend the counting until the next VSYNC signal is supplied. More specifically, the vertical counter cessation circuit 6 is structured to stop the counting of the vertical direction counter 3 at a predetermined timing according to the counter output of the vertical direction counter 3. Note that, the predetermined timing at which the vertical counter cessation circuit 6 stops the counting of the vertical direction counter 3 is described later.

Though the horizontal counter cessation circuit 5 and the vertical counter cessation circuit 6 are provided outside the horizontal direction counter 2 and the vertical direction counter 3 in the present embodiment, the present invention is not limited to this layout. For example, the horizontal direction counter 2 and the vertical direction counter 3 may be integrated into the horizontal counter cessation circuit 5 and the vertical counter cessation circuit 6, respectively.

The signal generating circuit group 4 generates various timing signals according to counter outputs of the horizontal direction counter 2 and the vertical direction counter 3, and includes a plurality of signal generating circuits for generating various timing signals for driving a liquid crystal display apparatus 100. In this embodiment, a SSP circuit 4a for generating a SSP signal, a GSP circuit 4b for generating a GSP signal, a GCK circuit 4c for generating a GCK signal, a FRP circuit 4d for generating a FRP signal used as a base signal for polarity inversion or the like of COM signals and image signals, a LR circuit 4e for generating a LR signal, a PWC circuit 4f for generating a PWC signal, a PCTL circuit 4g for generating a PCTL signal, and a UD circuit 4h for generating a UD signal. Note that, the signal generating circuits for constituting the signal generating circuit group 4 are not limited to those above. The signal generating circuit group 4 may be constituted of any signal generating circuits suitable for a conventional matrix-type display apparatus.

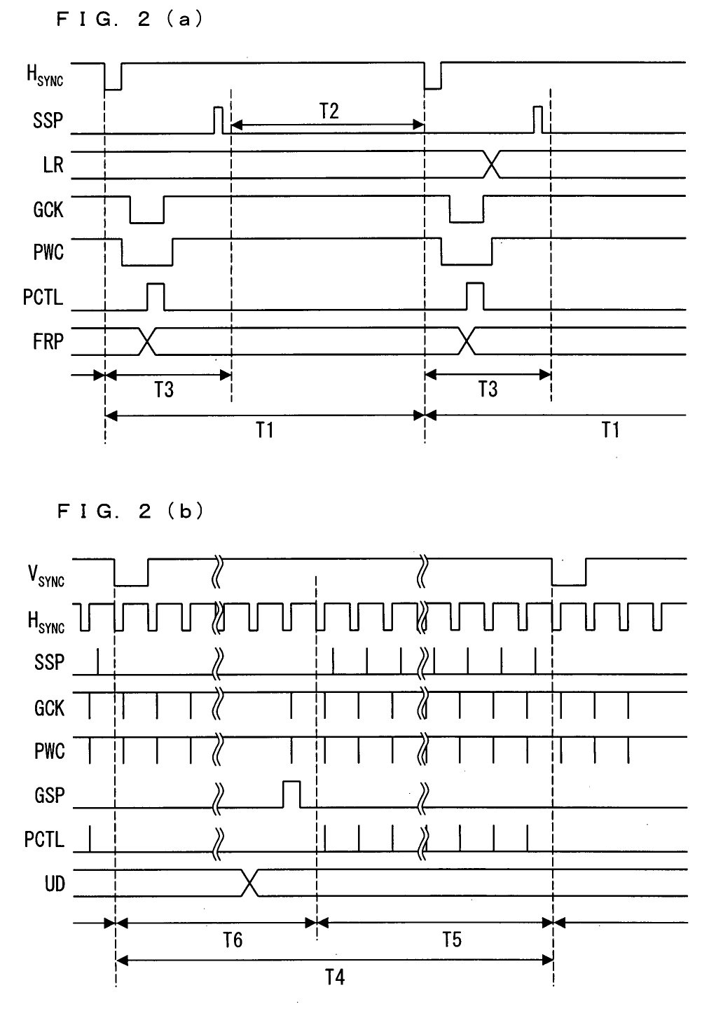

FIG. 2(a) and FIG. 2(b) each show a timing chart of the TG 10. FIG. 2(a) shows a timing chart in the horizontal direction, and FIG. 2(b) shows a timing chart in the vertical direction.

The following first explains the horizontal direction. The timing chart in the horizontal direction of FIG. 2(a) shows performance periods of the HSYNC signal, the SSP signal, the LR signal, the GCK signal, the PWC signal, the PCTL signal, the FRP signal, and the horizontal direction counter 2. As shown in the figure, the LR signal, the GCK signal, the PWC signal, the PCTL signal, and the FRP signal are each structured to have a change point immediately after the HSYNC becomes “Low”. The SSP signal has a change point following the changes of the LR signal, GCK signal, PWC signal, PCTL signal, and FRP signal after the HSYNC signal becomes “Low”.

A period from input of any given HSYNC signal to input of the next HSYNC signal is 1 horizontal scanning period T1 of an image signal. A single horizontal scanning period T1 of an image signal according to the present embodiment, that is, a period from the change of the HSYNC signal from “High” to “Low” and the change of the next HSYNC signal from “High” to “Low” is constituted of a horizontal effective display period T2 (horizontal effective display region) during which image signals including image information are outputted, and a horizontal blanking period T3. The timing signals: LR signal, GCK signal, PWC signal, PCTL signal, and FRP signal are each structured to have a change point during the horizontal blanking period T3. The horizontal effective display period T2 begins after generation of a change point in the SSP signal; that is, in FIG. 2(a), the period shown by the arrow above the waveform of the SSP signal denotes 1 horizontal effective display period T2.

The horizontal direction counter 2 needs to count the clock number to the point required by the signals outputted from the signal generating circuit group 4 (generally to the point of change). In the present embodiment, the horizontal direction counter 2 needs to continuously count the clock number at least during the period between the change of the HSYNC signal into “Low” and the generation of a change point in the SSP signal. That is, in the present embodiment, the horizontal direction counter 2 at least keeps counting the clock number during the horizontal blanking period T3.

In a period where the counting of horizontal direction counter 2 is not required, it is possible to reduce power consumption by suspending the counting operation of the horizontal direction counter 2. More specifically, by suspending the counting operation of horizontal direction counter 2 by the horizontal counter cessation circuit 5 in a period from the change points of all timing signals produced from the signal generating circuit group 4 to input of a new HSYNC signal in the 1 horizontal scanning period T1 of an image signal, power consumption can be reduced.

This structure is more minutely explained below, as shown in the TG 10 of the present embodiment in which the horizontal blanking period T3 begins at the time of input of an arbitrary HSYNC signal, followed by the horizontal effective display period T2 that continues until the next HSYNC signal is inputted, the horizontal counter cessation circuit 5 controls the horizontal direction counter 2 so that the horizontal direction counter 2 carries on counting at least during the horizontal blanking period T3, and suspends the counting thereafter until the next HSYNC signal is inputted. More specifically, a general function of the horizontal counter cessation circuit 5 can be described as control of the counting operation of the horizontal direction counter means so that the horizontal direction counter means suspends the counting operation for a certain period during the period from the change points of all timing signals produced from the signal generating circuit group 4 in response to input of an arbitrary horizontal reference signal to input of a new HSYNC signal in the 1 horizontal scanning period T1 of an image signal.

Note that, the horizontal direction counter 2 is required to carry out counting at least during the described period. However, it may of course carry on counting for a longer period. It however should be noted that power consumption increases as the counting period of the horizontal direction counter 2 increases. Therefore the counting period of the horizontal direction counter 2 should be set as short as possible, preferably only in the horizontal blanking period T3. More specifically, a preferred structure is such that the horizontal counter cessation circuit 5 causes the horizontal direction counter 2 to carry out counting only in the horizontal blanking period T3, and stop counting thereafter.

In other words, the signal generating circuit group 4 generates a change point for each of the all timing signals produced in 1 horizontal scanning period T1 of an image signal within the period where the horizontal direction counter 2 carries out counting of the clock numbers.

Further, in the signal generating circuit group 4, it is possible to use the SSP signal, which has a change point in the vicinity of the switching timing from the horizontal blanking period T3 into the horizontal effective display period T2, as a reference signal. In this case, the signal generating circuit group 4 at least includes a SSP circuit 4a for generating a SSP signal, and the SSP signal is structured to have a change point at the latest timing among the all timing signals produced from the signal generating circuit group 4 in response to input of an arbitrary horizontal reference signal during 1 horizontal scanning period T1. The horizontal counter cessation circuit 5 in this case can be described as means for controlling the horizontal direction counter 2 so that the horizontal direction counter 2 suspends the counting operation in a period from generation of a change in the SSP signal generated from the SSP circuit 4a of the signal generating circuit group 4 in response to input of an arbitrary horizontal reference signal to input of a new HSYNC signal.

Note that, though the 1 horizontal scanning period T1 is defined as a period starting from the change of the HSYNC signal into “Low” to the change of the next HSYNC signal into “Low” in the example above, the present invention is not limited to this. For example, 1 horizontal scanning period T1 may start when the HSYNC signal becomes “Low” and then becomes “High”, and continues until the next HSYNC signal becomes “Low” and then becomes “High”. Further, the HSYNC signal may have an identical duty ratio to the HSYNC signal of FIG. 2(a) with inversion of “High” and “Low”.

Next, the vertical direction is explained. The timing chart in the vertical direction of FIG. 2(b) shows performance periods of the VSYNC signal, the HSYNC signal, the SSP signal, the GCK signal, the PWC signal, the GSP signal, the PCTL signal, the UD signal, the horizontal effective display period T5 (horizontal effective display region), the vertical blanking period T6, and the vertical direction counter 3.

In this timing chart, a period between the change of the VSYNC signal into “Low” and the change of the next VSYNC signal into “Low”, i.e., 1 vertical scanning period T4 is constituted of the horizontal effective display period T5 (horizontal effective display region) and the vertical blanking period T6.

As shown in FIG. 2(b), the SSP signal and the PCTL signal are each structured to have a change point in the horizontal effective display period T5. Further, change points of the GCK signal and the PWC signal are generated mostly in the horizontal effective display period T5, but slight change points of them can be seen also in the vertical blanking period T6. The GSP signal is structured to have a change point after the start of vertical blanking period T6 at the change of VSYNC signal into “Low”, immediately before switching from the vertical blanking period T6 to the horizontal effective display period T5. The UD signal is also structured to have a change point after the start of vertical blanking period T6 at the change of VSYNC signal into “Low”, immediately before change from the vertical blanking period T6 to the horizontal effective display period T5, but the generation timing of the change of the UD signal is earlier than the change of the GSP signal. Note that, such a timing chart results from usual cessation of the signals (eg. SSP signal) in the vertical blanking period T6 for power saving.

More specifically, the TG 10 of the present embodiment is arranged so that the vertical blanking period T6 of an image signal starts from input of an arbitrary VSYNC signal, followed by the horizontal effective display period T5 which ends when the next VSYNC signal is inputted.

The vertical direction counter 3 is required to count the clock numbers at least during the vertical blanking period T6 so as to find the switching timing from the vertical blanking period T6 to the horizontal effective display period T5, i.e., the start point of the horizontal effective display period T5. After the start point of the horizontal effective display period T5 is found by the vertical direction counter 3, the vertical direction counter 3 is stopped to save power.

Therefore, the vertical counter cessation circuit 6 controls the vertical direction counter 3 so that the vertical direction counter 3 carries on counting of clock number at least in the vertical blanking period T6 and suspends the counting at a predetermined timing before the next VSYNC signal is supplied. The vertical counter cessation circuit 6 more preferably controls the vertical direction counter 3 so that the vertical direction counter 3 carries on the counting only in the vertical blanking period T6 and stops the counting thereafter. This arrangement achieves further power saving.

A general function of such a vertical counter cessation circuit 6 can be described as control of the counting operation of the horizontal direction counter means so that the horizontal direction counter means suspends the counting operation in a period from the change points of all timing signals produced from the signal generating circuit in response to input of an arbitrary horizontal reference signal to input of a new vertical reference signal during 1 vertical scanning period T4 of an image signal.

Further, in the signal generating circuit group 4, it is possible to use the GSP signal, which has a change point in the vicinity of the switching timing from the vertical blanking period T6 to the vertical effective display period T5, as a reference signal. In this case, the signal generating circuit group 4 at least includes a GSP circuit 4a for generating a GSP signal, and the vertical counter cessation circuit 6 causes the vertical direction counter 3 to stop counting the clock number after the change of the GSP signal supplied from the signal generating circuit group 4 is generated after input of an arbitrary vertical reference signal until a new VSYNC signal is inputted.

Note that, though the 1 vertical scanning period T4 is defined as a period starting from the change of the VSYNC signal into “Low” to the change of the next VSYNC signal into “Low” in the example above, the present invention is not limited to this. For example, 1 vertical scanning period T4 may start when the VSYNC signal becomes “Low” and then becomes “High”, until the next VSYNC signal becomes “Low” and then becomes “High”. Further, the VSYNC signal may have an identical duty ratio to the VSYNC signal of FIG. 2(b) with inversion of “High” and “Low”.

As described, the TG 10 and the liquid crystal display apparatus 100 including the TG 10 according to the present embodiment comprises counter cessation means (horizontal counter cessation circuit 5, vertical counter cessation circuit 6) for stopping the horizontal direction counter 2 and the vertical direction counter 3 after they are operated for a predetermined time. This gives an effect of reduction in operation time of the horizontal direction counter 2 and the vertical direction counter 3, which also result is reduction in power consumption for the corresponding amount.

This reduction of counting number in the horizontal direction counter 2 and in the vertical direction counter 3 allows reduction in amount of wiring from the horizontal direction counter 2 and the vertical direction counter 3 to the TG 10 (For example, on a panel layout), thereby achieving reduction of circuit area (frame area).

Further, in the block diagram of FIG. 1, wirings may be provided to connect the horizontal counter cessation circuit 5 and the vertical counter cessation circuit 6 to the signal generating circuit group 4.

Moreover, since the foregoing structure also reduces the counter bit number determined in the signal generating circuit group 4, it is possible to reduce the size of detection circuit in the signal generating circuit group 4 for detecting the change point of a signal. This also contributes to reduction of circuit area.

Furthermore, in the case of using a horizontal direction counter 2 and a vertical direction counter 3 synchronized with each other, the reduction of bit number results in reduction of load to the transmission line of the CLK signals, and thereby power can be further saved, and the circuit area can be further reduced (reduction of frame/miniaturization of CLK line buffer).

Note that, in the present invention, the horizontal direction counter and the vertical direction counter may be either synchronized or not synchronized. Further, since the present embodiment uses a binary counter, the present invention is not limited. For example, it is possible to use a BCD counter which ensures the same result. The binary counter is however preferred.

Note that, though the present embodiment uses the TG 10 including both the horizontal counter cessation circuit 5 and the vertical counter cessation circuit 6, the objective of the present invention, i.e., power reduction, can be attained by either or both of the horizontal counter cessation circuit 5 and the vertical counter cessation circuit 6. Accordingly, a TG 10 or a display apparatus including one of the horizontal counter cessation circuit 5 and the vertical counter cessation circuit 6 is included in the range of the present invention.

Further, the present invention is not limited to the foregoing embodiment above, and can be appropriately generalized on the basis of the technical standard at the time of filing of the present invention. For example, the timing signal generating apparatus according to the present invention is applicable not only to a matrix-type liquid crystal display apparatus, but also to a structure, which is at least supplied with a reference signal and outputs a timing signal to a drive circuit for driving electronic elements arranged in an array. In this case, the timing signal generating apparatus according to the present invention includes counter means for carrying out counting operation based on a reference signal; a signal generation circuit for generating the timing signal according to counter output of the counter means; and counter cessation means for stopping counting operation of the counter means during a period from input of an arbitrary reference signal to input of the next reference signal.

Note that, the term “array” in the present specification denotes both a line and a matrix.

Further, the range of present invention also includes a timing signal generating apparatus at least supplied with a clock signal and a horizontal reference signal, and outputs a timing signal to a horizontal drive circuit for driving electronic elements arranged in a matrix. In this case, the timing signal generating apparatus according to the present invention includes horizontal direction counter means for carrying out counting operation of clock signals based on the horizontal reference signal; a signal generation circuit for generating the timing signal according to counter output of the horizontal direction counter means; and horizontal counter cessation means for stopping counting operation of the horizontal direction counter means during a period from input of an arbitrary horizontal reference signal to input of the next horizontal reference signal.

Further, the range of present invention also includes a timing signal generating apparatus at least supplied with a horizontal reference signal and a vertical reference signal, and outputs a timing signal to a vertical drive circuit for driving electronic elements arranged in a matrix. In this case, the timing signal generating apparatus according to the present invention includes vertical direction counter means for carrying out counting operation of pulse number of the horizontal signals based on the vertical reference signal; a signal generation circuit for generating the timing signal according to counter output of the vertical direction counter means; and the vertical counter cessation means for stopping counting operation of the vertical direction counter means during a period from input of an arbitrary vertical reference signal to input of the next vertical reference signal.

Further, the range of present invention also includes a timing signal generating apparatus realized by a combination of foregoing techniques. Specifically, the range of present invention includes a timing signal generating apparatus at least supplied with a clock signal, a horizontal reference signal, and a vertical reference signal, and outputs a timing signal to a horizontal drive circuit and a vertical drive circuit which each drive electronic elements arranged in a matrix. In this case, the timing signal generating apparatus according to the present invention includes horizontal direction counter means for carrying out counting operation of clock number of clock signals based on the horizontal reference signal; vertical direction counter means for carrying out counting operation of pulse number of the horizontal reference signals based on the vertical reference signal; a signal generation circuit for generating the timing signal according to counter output of the horizontal direction counter means and counter output of the vertical direction counter means; horizontal counter cessation means for stopping counting operation of the horizontal direction counter means during a period from input of an arbitrary horizontal reference signal to input of the next horizontal reference signal; and the vertical counter cessation means for stopping counting operation of the vertical direction counter means during a period from input of an arbitrary vertical reference signal to input of the next vertical reference signal.

Further, the range of present invention also includes a timing signal generating apparatus at least supplied with a clock signal and a vertical reference signal, and outputs a timing signal to a drive circuit for driving electronic elements arranged in a matrix. In this case, the timing signal generating apparatus according to the present invention includes vertical direction counter means for carrying out counting operation of clock number of clock signals based on the vertical reference signal; a signal generation circuit for generating the timing signal according to counter output of the vertical direction counter means; and the vertical counter cessation means for stopping counting operation of the vertical direction counter means during a period from input of an arbitrary reference signal to input of the next reference signal.

The foregoing timing signal generating apparatus may be controlled so that the counting operation of the horizontal direction counter means is started in response to input of the horizontal reference signal and the horizontal counter cessation means causes the horizontal direction counter means to stop the counting after generation of a change point of the timing signal, the counting being suspended until the next horizontal reference signal is supplied.

The foregoing timing signal generating apparatus may be controlled so that the counting operation of the vertical direction counter means is started in response to input of the vertical reference signal and the vertical counter cessation means causes the vertical direction counter means to stop the counting after generation of a change point of the timing signal, the counting being suspended until the next vertical reference signal is supplied.

### Second Embodiment

Another embodiment of the present invention is described below. For ease of explanation, materials having the equivalent functions as those shown in the drawings pertaining to the foregoing First Embodiment will be given the same reference symbols, and explanation thereof will be omitted here. The present embodiment only describes features different from those of First Embodiment.

In the First Embodiment, reduction of power consumption was achieved by stopping the horizontal direction counter 2 and the vertical direction counter 3. In this case, since the horizontal direction counter 2 and the vertical direction counter 3 do not carry out counting in the cessation period, it is possible to use a counter with reduced bit numbers by the quantity of the cessation period.

In view of this, the present embodiment achieves reduction of power consumption by stopping a horizontal direction counter 2′ and a vertical direction counter 3′ at a predetermined timing, and also by reducing the bit number of the counters of the horizontal direction counter 2′ and the vertical direction counter 3′. Note that, apart from the horizontal direction counter 2′ and the vertical direction counter 3′, the present invention is identical to the First Embodiment. For ease of explanation, the following explains an example of displaying a VGA image.

In displaying a VGA image of 60 Hz VESA compliance, the image region of the active-matrix liquid crystal display apparatus is: dot clock 25.175 MHz, 800 dot (horizontal direction)×525 line (vertical direction), including the blanking period. This condition of 800×525 individually require 10 bits. Note that, effective display period (effective image region) is: 640 dot (horizontal direction)×480 line (vertical direction).

As described, the horizontal direction counter 2 and the vertical direction counter 3 in the TG 10 need to count the clock number to the point required by the signals outputted from the signal generating circuit group 4 (generally to the point of change).

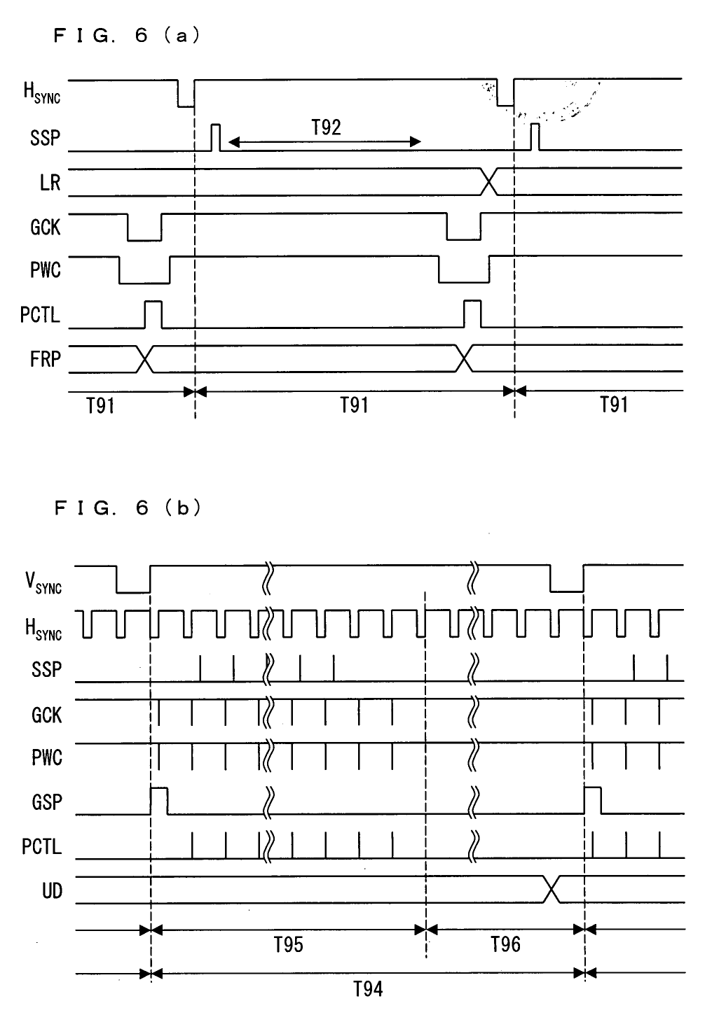

The following first explains a horizontal direction counter and the vertical direction counter provided in a conventional liquid crystal display apparatus. As shown in FIG. 6(a), in the horizontal direction, the GCK signal and the FRP signal are each structured to have a change point after the HSYNC signal becomes “Low”, and slightly before the next HSYNC signal becomes “Low”. Since these signals are generally in the blanking period, the change points of the GCK signal and the FRP signal are not less than 641 and not more than 800. Accordingly, the horizontal direction counter of a conventional liquid crystal display apparatus requires 10 bits.

Next, as to the vertical direction, as described, the SSP signal is stopped in the vertical blanking period T96 for power saving. As shown in FIG. 6(b), the point where the output of the SSP signal is stopped (the point where generation of change of the SSP signal is stopped) resides after the change of the VSYNC signal into “Low”, immediately before the change of the next VSYNC signal into “Low”. Since the vertical direction counter is required to count the horizontal numbers in the effective display region so as to detect the start position of the vertical blanking period T96, the vertical direction counter counts at least 481 up to 525. Therefore, the vertical direction counter of a conventional liquid crystal display apparatus requires 9 bits to 10 bits.

Next, the following explains a liquid crystal display apparatus according to the present embodiment. The foregoing theory of the conventional art can be applied also to the present embodiment. That is, as shown in FIG. 2(a), in the horizontal direction, the change points of the GCK signal, FRP signal etc. reside immediately after the point where the temporarily fallen HSYNC signal rises to “High” again. The SSP signal has a change point at the latest timing.

The change points of these signals generally reside in the blanking period T3, meaning that all the signals have been through changes when the counting comes to the maximum number (160). Accordingly, in comparison with the conventional art in which the counter requires 10 bits, the horizontal direction counter 2′ of the present embodiment requires at least 8 bits. Note that, the horizontal direction counter 2′ stops counting when the counter comes to the end, and suspends the operation until the HSYNC signal becomes “Low” again. During this period, the TG 10 outputs signals having no change.

Also in the vertical direction, the vertical blanking period T6 begins when the VSYNC signal becomes “Low”, and the subsequent horizontal effective display period T5 (effective display region) continues until the next VSYNC signal becomes “Low”. In a conventional liquid crystal display apparatus, the vertical direction counter serves to find the start point of the vertical blanking period T6; however, the vertical counter of the present embodiment serves to find the start point of the horizontal effective display period T5. In this case, the vertical direction counter 3′ carries out counting to at least 45, corresponding to the vertical blanking period T6, and therefore requires at least 6 bits.

Accordingly, the horizontal direction counter 2 is realized by a counter whose bit number is less than the bit number for expressing a binary number converted from the division result of 1 horizontal scanning period T1 by a single period of clock signal. More preferably, the horizontal direction counter 2 is realized by a counter whose bit number is enough to express a binary number expressing the horizontal blanking period T3.

Further, in the present embodiment in which the horizontal blanking period T3 of an image signal begins in response to the input of an arbitrary HSYNC signal, and the subsequent horizontal effective display period T2 continues until the next HSYNC signal is supplied, the horizontal counter cessation circuit 5 preferably stops counting operation either at a predetermined timing between the end of the horizontal blanking period T3 and the end of counting by the horizontal direction counter 2 or immediately at the end of the counting of the horizontal direction counter 2. For example, in the assumed simplest structure, the horizontal counter cessation circuit 5 stops the horizontal direction counter 2 when the counter of the horizontal direction counter 2 comes to the end. Alternatives are a structure in which the counting is stopped at a timing several clocks after the end of the horizontal blanking period T3 and a structure in which the signal generation circuit group stops referring to the count value immediately at the end of the counting operation of the horizontal direction counter 2. Note that, in terms of power saving, the structure in which the counting immediately stops at the end of the horizontal blanking period T3 is most preferred.

Further, the vertical direction counter 3 is realized by a counter whose bit number is less than the bit number for expressing a binary number converted from the division result of 1 vertical scanning period T4 by 1 horizontal scanning period T1. More preferably, the vertical direction counter 3 is realized by a counter whose bit number is no less than the bit number for expressing a binary number converted from the division result of the vertical blanking period T6 by 1 horizontal scanning period T1.

Further, in the present embodiment in which the vertical blanking period T6 of an image signal begins in response to the input of an arbitrary VSYNC signal, and the subsequent vertical effective display period T5 continues until the next VSYNC signal is supplied, the vertical counter cessation circuit 6 preferably stops counting operation either at a predetermined timing between the end of the vertical blanking period T6 and the end of counting by the vertical direction counter 3 or immediately at the end of the counting of the vertical direction counter 3. For example, in the assumed simplest structure, the vertical counter cessation circuit 6 stops the vertical direction counter 3 when the counter of the vertical direction counter 3 comes to the end. An alternative is a structure in which the counting is stopped at a timing several clocks after the end of the horizontal blanking period T3. Note that, in terms of power saving, the structure in which the counting immediately stops at the end of the horizontal blanking period T3 is most preferred.

As described, the timing signal generating apparatus according to the present embodiment includes counter cessation means for stopping a horizontal direction counter and a vertical direction counter at predetermined timings; and a horizontal direction counter and a vertical direction counter of less number of bits.

Therefore, in addition to the effect given by the structure of First Embodiment, the bit numbers of the horizontal direction counter and the vertical direction counter are reduced, and thereby the circuit scale is reduced. This provides effects of reduction in power consumption, and reduction in circuit area (frame area).

Further, in the structure using the horizontal direction counter 2 and/or the vertical direction counter 3 having less number of bits, it is possible to set the signal generation circuit group to stop referring to the counting value of the vertical direction counter 3 when the counting operation is finished. Even with such a modification, since the counting operation is stopped, the power is saved and the circuit area (reduction in frame area) is reduced compared with the structure requires continuous counting. Further, malfunction of the signal generating circuit group 4 can be prevented.

Note that, the foregoing example related to VGA display, but the present invention is not limited to VGA display, and its effect becomes more significant in a larger image format (for example, SVGA, XGA etc.). The present invention is particularly effective for an original image format with a large number of pixels and short horizontal and vertical blanking period.

Further, in the present embodiment, both of the horizontal direction counter and the vertical direction counter have less number of bits, but the present invention is not limited to this structure. More specifically, reduction in power consumption and in circuit area can be achieved by reducing at least one of the bit numbers of the horizontal direction counter and the vertical direction counter. This structure is also included in the range of the present invention.

Finally, a matrix-type display apparatus including the timing signal generating apparatus according to the present invention is also included in the range of the present invention. Apart from the described active-matrix liquid crystal display apparatus, the matrix-type display apparatus also includes DMD, EL, FED, LED, PDP, and fluorescent display tube, for example.

Further, the timing signal generating apparatus may be realized as an IC chip, or may be formed on a substrate monolithically with the image display elements. A particularly preferable structure is an active-matrix liquid crystal display apparatus in which the timing signal generating apparatus is formed on a substrate monolithically with the image display elements.

Further, the present invention is not limited to the embodiments above and may be appropriately generalized on the basis of the technical standard at the time of filing of the invention.

The range of the present invention also includes a method for driving a matrix-type display apparatus including the timing signal generating apparatus. One of the methods is a driving method for an electronic apparatus comprising: electronic elements arranged in an array; a drive circuit for driving the electronic elements; and a timing signal generating apparatus which generates a timing signal and outputs the timing signal to the drive circuit based on a reference signal, the timing signal generating apparatus comprising: counter means for carrying out counting operation based on the reference signal; and a signal generation circuit for generating the timing signal according to counter output of the counter means, the method comprising the step of: suspending or finishing counting operation of the counter means during a period from input of an arbitrary reference signal to input of a next reference signal.

“Finish the counting” denotes output of a pulse for indicating the end of the counter when the counting comes to the end, so that the signal generation circuit stops referring to the counter.

Another method is a driving method for an electronic apparatus comprising: electronic elements arranged in a matrix; a drive circuit for driving the electronic devices; and a timing signal generating apparatus which generates a timing signal and outputs the timing signal to the drive circuit based on a horizontal reference signal and a clock signal, the timing signal generating apparatus comprising: horizontal direction counter means for carrying out counting operation of a clock number of the clock signal based on the horizontal reference signal; and a signal generation circuit for generating a plurality of timing signals according to counter output of the horizontal direction counter means, the method comprising the step of: suspending or finishing counting operation of the horizontal direction counter means during a period from input of an arbitrary horizontal reference signal to input of a next horizontal reference signal.

Another method is a driving method for an electronic apparatus comprising: electronic elements arranged in a matrix; a drive circuit for driving the electronic elements; and a timing signal generating apparatus which generates a timing signal and outputs the timing signal to the drive circuit based on a vertical reference signal and a horizontal reference signal, the timing signal generating apparatus comprising: vertical direction counter means for counting a pulse number of the horizontal reference signal based on the vertical reference signal; and a signal generation circuit for generating a plurality of timing signals according to counter output of the vertical direction counter means, the method comprising the step of: suspending or finishing counting operation of the vertical counter means during a period from input of an arbitrary vertical reference signal to input of a next vertical reference signal.

The foregoing techniques may be combined. More specifically, the present invention also includes a driving method for an electronic apparatus comprising: electronic elements arranged in a matrix; vertical and horizontal drive circuits for driving the electronic elements; and a timing signal generating apparatus which generates a plurality of timing signals and outputs the timing signals to the vertical and horizontal drive circuits based on a horizontal reference signal and a vertical reference signal, the timing signal generating apparatus comprising: horizontal direction counter means for counting a clock number based on the horizontal reference signal; and vertical direction counter means for counting a pulse number based on the vertical reference signal, the method comprising the steps of: causing the horizontal direction counter means to start counting operation upon input of the horizontal reference signal, and suspending or finishing counting operation of the horizontal direction counter means thereafter, the counting operation being suspended or finished until a next horizontal reference signal is supplied; and causing the vertical direction counter means to start counting operation upon input of the vertical reference signal, and suspending or finishing counting operation of the vertical direction counter means thereafter, the counting operation being suspended or finished until a next vertical reference signal is supplied.

Another method is a driving method for an electronic apparatus comprising: electronic elements arranged in a matrix; a drive circuit for driving the electronic elements; and a timing signal generating apparatus which generates a plurality of timing signals and outputs the timing signals to the drive circuit based on a vertical reference signal and a clock signal, the timing signal generating apparatus comprising: counter means for counting a clock number of the clock signal based on the vertical reference signal; and a signal generation circuit for generating a plurality of timing signals according to counter output of the counter means, the method comprising the step of: suspending or finishing counting operation of counter means during a period from input of an arbitrary reference signal to input of a next reference signal.

The range of the present invention further includes a driving method for an electronic apparatus comprising: electronic elements arranged in an array; a drive circuit for driving the electronic elements; and a timing signal generating apparatus which generates a timing signal and outputs the timing signal to the drive circuit based on a reference signal, the timing signal generating apparatus comprising: counter means for carrying out counting operation based on the reference signal; and a signal generation circuit for generating the timing signal according to counter output of the counter means, the counter means is formed of a counter whose bit number is less than a bit number for expressing a binary number converted from a division result of 1 period of the reference signal by a period of the signal counted by the counter means, the method comprising the step of: outputting a control signal so that the signal generation circuit to stop referring to a signal number counted by the counter means at an end of counter of the counter means.

Though the foregoing embodiments described an active-type display apparatus with pixels arranged in a matrix, the present invention is also applicable to other types of electronic apparatus in which electronic elements are arranged in an array. More specifically, the present invention is useful for a fluorescent display tube having display elements arranged in a line or in a matrix, a scanner in which photoreceptors are arranged in a line or in a matrix, an image processing IC, a fingerprint authentication apparatus or the like. Further, the present invention is also useful for an image-capturing apparatus applying the display elements of a display apparatus as image-receiving elements. In this case, as with the display apparatus, an image-capturing apparatus in which a timing signal generating apparatus and photoreceptors are monolithically formed is particularly preferred.

As described, the timing signal generating means according to the present invention operates the horizontal direction counter means and/or the vertical direction counter means for a predetermined time, and then stops them. Therefore, the operation of the horizontal direction counter means and/or the vertical direction counter means are stopped for a certain period. The timing signal generating means according to the present invention thus provides an effect of power saving.

Further, with an electronic apparatus or a matrix-type display apparatus using the timing signal generating means according to the present invention, it is possible to reduce power consumed by counter means in an electronic apparatus, in a matrix-type display apparatus, or in an image-reception apparatus.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

As described, the present invention is applicable not only to a matrix-type display apparatus using display elements of liquid crystal, PDP, organic EL, LED, FED, DMD etc, but also to the whole of various electronic devices in which electronic elements are arranged in an array, such as a fluorescent display tube having display elements arranged in a line or in a matrix, a scanner in which photoreceptors are arranged in a line or in a matrix or the like. The present invention provides an effect of power saving in these electronics apparatuses. The present invention is useful for many other industrial fields.

1. A timing signal generating apparatus which is at least supplied with a reference signal and outputs a timing signal to a drive circuit for driving electronic elements arranged in an array,
the timing signal generating apparatus comprising: counter means for carrying out counting operation based on the reference signal;
a signal generation circuit for generating the timing signal according to counter output of the counter means; and
counter cessation means capable of stopping counting operation of the counter means during a period from input of an arbitrary reference signal to input of a next reference signal.

2. A timing signal generating apparatus which is at least supplied with a clock signal and a horizontal reference signal and outputs a timing signal to a horizontal drive circuit for driving electronic elements arranged in a matrix,
the timing signal generating apparatus comprising:
horizontal direction counter means for carrying out counting operation of the clock signal based on the horizontal reference signal;
a signal generation circuit for generating the timing signal according to counter output of the horizontal direction counter means; and
horizontal counter cessation means capable of stopping counting operation of the horizontal direction counter means during a period from input of an arbitrary horizontal reference, signal to input of a next horizontal reference signal.

3. A timing signal generating apparatus which is at least supplied with a horizontal reference signal and a vertical reference signal and outputs a timing signal to a vertical drive circuit for driving electronic elements arranged in a matrix,
the timing signal generating apparatus comprising: vertical direction counter means for counting a pulse number of the horizontal reference signal based on the vertical reference signal;
a signal generation circuit for generating the timing signal according to counter output of the vertical direction counter means; and
vertical counter cessation means capable of stopping counting operation of the vertical counter means during a period from input of an arbitrary vertical reference signal to input of a next vertical reference signal.

4. A timing signal generating apparatus which is at least supplied with a horizontal reference signal, a vertical reference signal, and a clock signal and outputs a timing signal to a horizontal and vertical drive circuit for driving electronic elements arranged in a matrix,
the timing signal generating apparatus comprising:
horizontal direction counter means for counting a clock number of the clock signal based on the horizontal reference signal;
vertical direction counter means for counting a pulse number of the horizontal reference signal based on the vertical reference signal;
a signal generation circuit for generating the timing signal according to counter outputs of the horizontal direction counter means and the vertical direction counter means;
the timing signal generating apparatus further comprising:
horizontal counter cessation means capable of stopping counting operation of the horizontal direction counter means during a period from input of an arbitrary horizontal reference signal to input of a next horizontal reference signal; and
vertical counter cessation means capable of stopping counting operation of the vertical direction counter means during a period from input of an arbitrary vertical reference signal to input of a next vertical reference signal.

5. A timing signal generating apparatus which is at least supplied with a clock signal and a vertical reference signal and outputs a timing signal to a drive circuit for driving electronic elements arranged in a matrix,
the timing signal generating apparatus comprising: vertical counter means for counting a clock number of the clock signal based on the vertical reference signal;
a signal generation circuit for generating the timing signal according to counter output of the vertical counter means; and
vertical counter cessation means capable of stopping counting operation of the vertical counter means during a period from input of an arbitrary reference signal to input of a next reference signal.

6. The timing signal generating apparatus as set forth in claim 2, further comprising: a control section which starts the counting operation of the horizontal direction counter means in response to input of the horizontal reference signal, generates a change point of the timing signal, and causes the horizontal counter cessation means to stop the counting operation of the horizontal direction counter means, the counting operation being suspended until a next horizontal reference signal is supplied.

7. The timing signal generating apparatus as set forth in claim 3, further comprising: a control section which starts the counting operation of the vertical direction counter means in response to input of the vertical reference signal, generates a change point of the timing signal, and causes the vertical counter cessation means to stop the counting operation of the vertical direction counter means, the counting operation being suspended until a next vertical reference signal is supplied.

8. The timing signal generating apparatus as set forth in claim 2, wherein the electronic elements arranged in a matrix are display pixels arranged in a matrix, and the signal generation circuit generates change points of all timing signals produced in 1 horizontal scanning period of an image signal, during the counting operation of the horizontal direction counter means.

9. The timing signal generating apparatus as set forth in claim 2, wherein the electronic elements arranged in a matrix are display pixels arranged in a matrix, and the horizontal counter cessation means suspends the counting operation of the horizontal direction counter means so that the suspension period resides in a period from the change points of all timing signals produced from the signal generating circuit to input of a new horizontal reference signal within 1 horizontal scanning period of an image signal which starts in response to input of an arbitrary horizontal reference signal.

10. The timing signal generating apparatus as set forth in claim 3, wherein the electronic elements arranged in a matrix are display pixels arranged in a matrix, and the vertical counter cessation means suspends the counting operation of the vertical direction counter means so that the suspension period resides in a period from the change points of all timing signals produced from the signal generating circuit to input of a new vertical reference signal within 1 vertical scanning period of an image signal which starts in response to input of an arbitrary vertical reference signal.

11. The timing signal generating apparatus as set forth in claim 2, wherein the electronic elements arranged in a matrix are display pixels arranged in a matrix, and the signal generating circuit at least includes a circuit for generating a shift start signal of the horizontal drive circuit and generates a plurality of timing signals,
the shift start signal of the horizontal drive circuit is structured to have a change point at a latest timing among all timing signals produced from the signal generating circuit during 1 horizontal scanning period of an image signal which starts in response to input of an arbitrary horizontal reference signal, and
the horizontal counter cessation means suspends the counting operation of the horizontal direction counter means so that the suspension period resides in a period from a change point of a shift start signal of a source drive circuit which is produced from the signal generating circuit after the input of an arbitrary horizontal reference signal, to input of a new horizontal reference signal.

12. The timing signal generating apparatus as set forth in claim 3, wherein the electronic elements arranged in a matrix are display pixels arranged in a matrix, and the signal generating circuit at least includes a circuit for generating a shift start signal of the vertical drive circuit and generates a plurality of timing signals, and
the vertical counter cessation means suspends the counting operation of the vertical direction counter means so that the suspension period resides in a period from a change point of the shift start signal of the vertical drive circuit, which is produced from the signal generating circuit after input of an arbitrary vertical reference signal, to input of a new horizontal reference signal.

13. The timing signal generating apparatus as set forth in claim 2, wherein the electronic elements arranged in a matrix are display pixels arranged in a matrix, and the timing signal generating apparatus is arranged so that a horizontal blanking period of an image signal begins in response to input of an arbitrary horizontal reference signal, and a subsequent horizontal effective display period continues until a next horizontal reference signal is supplied, and
the horizontal counter cessation means controls the horizontal direction counter means so that the horizontal direction counter means carries out the counting operation at least in the horizontal blanking period and then suspends the counting operation for a certain period until a next horizontal reference signal is supplied.

14. The timing signal generating apparatus as set forth in claim 3, wherein the electronic elements arranged in a matrix are display pixels arranged in a matrix, and the timing signal generating apparatus is arranged so that a vertical blanking period of an image signal begins in response to input of an arbitrary vertical reference signal, and a subsequent vertical effective display period continues until a next vertical reference signal is supplied, and
the vertical counter cessation means controls the vertical direction counter means so that the vertical direction counter means carries out the counting operation at least in the vertical blanking period and then suspends the counting operation for a certain period until a next vertical reference signal is supplied.

15. The timing signal generating apparatus as set forth in claim 2, wherein the electronic elements arranged in a matrix are display pixels arranged in a matrix, and the timing signal generating apparatus is arranged so that a horizontal blanking period of an image signal begins in response to input of an arbitrary horizontal reference signal, and a subsequent horizontal effective display period continues until a next horizontal reference signal is supplied, and
the horizontal counter cessation means controls the horizontal direction counter means so that the horizontal direction counter means carries out the counting operation only in the horizontal blanking period and then suspends the counting operation until a next horizontal reference signal is supplied.

16. The timing signal generating apparatus as set forth in claim 3, wherein the electronic elements arranged in a matrix are display pixels arranged in a matrix, and the timing signal generating apparatus is arranged so that a horizontal blanking period of an image signal begins in response to input of an arbitrary horizontal reference signal, and a subsequent horizontal effective display period continues until a next horizontal reference signal is supplied, and
the horizontal counter cessation means controls the horizontal direction counter means so that the horizontal direction counter means carries out the counting operation only in the horizontal blanking period and then suspends the counting operation until a next horizontal reference signal is supplied.

17. A timing signal generating apparatus which is at least supplied with a reference signal and outputs a signal to a drive circuit for driving electronic elements arranged in an array,
the timing signal generating apparatus comprising: counter means for carrying out counting operation based on the reference signal; and
a signal generation circuit for generating the timing signal according to counter output of the counter means,
a bit number of the counter means being less than a bit number for expressing a binary number converted from a division result of 1 period of the reference signal by a period of a signal counted by the counter means.

18. A timing signal generating apparatus which is at least supplied with a reference signal and outputs a timing signal to a drive circuit for driving electronic elements arranged in a matrix,
the timing signal generating apparatus comprising:
counter means for carrying out counting operation based on the reference signal; and
a signal generation circuit for generating the timing signal according to counter output of the counter means,
a bit number of the counter means being less than a bit number for expressing a binary number converted from a division result of 1 period of the reference signal by a period of a signal counted by the counter means.

19. The timing signal generating apparatus as set forth in claim 2, wherein
the horizontal direction counter means is realized by a counter whose bit number is less than a bit number for expressing a binary number converted from a division result of 1 horizontal scanning period by a period of the clock signal.

20. The timing signal generating apparatus as set forth in claim 3, wherein
the vertical direction counter means is realized by a counter whose bit number is less than a bit number for expressing a binary number converted from a division result of 1 vertical scanning period by a horizontal scanning period.

21. The timing signal generating apparatus as set forth in claim 3, wherein
the vertical direction counter means is realized by a counter whose bit number is less than a bit number for expressing a binary number converted from a division result of 1 vertical scanning period by a period of the clock signal.

22. The timing signal generating apparatus as set forth in claim 19, wherein the electronic elements arranged in a matrix are display pixels arranged in a matrix, and the timing signal generating apparatus is arranged so that a horizontal blanking period of an image signal begins in response to input of an arbitrary horizontal reference signal, and a subsequent horizontal effective display period continues until a next horizontal reference signal is supplied, and
the horizontal counter cessation means stops the counting operation of the horizontal direction counter means at a timing between an end of the horizontal blanking period and an end of counter of the horizontal direction counter means.

23. The timing signal generating apparatus as set forth in claim 20, wherein the electronic elements arranged in a matrix are display pixels arranged in a matrix, and the timing signal generating apparatus is arranged so that a vertical blanking period of an image signal begins in response to input of an arbitrary vertical reference signal, and a subsequent vertical effective display period continues until a next vertical reference signal is supplied, and
the vertical counter cessation means stops the counting operation of the vertical direction counter means at a timing between an end of the vertical blanking period and an end of counter of the vertical direction counter means.

24. An electronic apparatus including the timing signal generating apparatus as set forth in claim 1.

25. A display apparatus including the timing signal generating apparatus as set forth in claim 8.

26. A display apparatus as set forth in claim 25, wherein the timing signal generating apparatus is formed on a substrate monolithically with the image display elements.

27. An image-reception apparatus including the timing signal generating apparatus as set forth in claim 8, wherein the timing signal generating apparatus is formed on a substrate monolithically with image-receiving elements.

28. A driving method for an electronic apparatus comprising:
electronic elements arranged in an array;
a drive circuit for driving the electronic elements; and
a timing signal generating apparatus which generates a timing signal and outputs the timing signal to the drive circuit based on a reference signal,
the timing signal generating apparatus comprising:
counter means for carrying out counting operation based on the reference signal; and
a signal generation circuit for generating the timing signal according to counter output of the counter means, the method comprising the step of:
suspending or finishing counting operation of the counter means during a period from input of an arbitrary reference signal to input of a next reference signal.

29. A driving method for an electronic apparatus comprising:
electronic elements arranged in a matrix;
a drive circuit for driving the electronic devices; and
a timing signal generating apparatus which generates a timing signal and outputs the timing signal to the drive circuit based on a horizontal reference signal and a clock signal,
the timing signal generating apparatus comprising: horizontal direction counter means for carrying out counting operation of a clock number of the clock signal based on the horizontal reference signal; and
a signal generation circuit for generating the timing signal according to counter output of the horizontal direction counter means,
the method comprising the step of:
suspending or finishing counting operation of the horizontal direction counter means during a period from input of an arbitrary horizontal reference signal to input of a next horizontal reference signal.

30. A driving method for an electronic apparatus comprising:
electronic elements arranged in a matrix;
a drive circuit for driving the electronic elements; and
a timing signal generating apparatus which generates a timing signal and outputs the timing signal to the drive circuit based on a vertical reference signal and a horizontal reference signal,
the timing signal generating apparatus comprising:
vertical direction counter means for counting a pulse number of the horizontal reference signal based on the vertical reference signal; and
a signal generation circuit for generating a plurality of timing signals according to counter output of the vertical direction counter means,
the method comprising the step of:
suspending or finishing counting operation of the vertical counter means during a period from input of an arbitrary vertical reference signal to input of a next vertical reference signal.

31. A driving method for an electronic apparatus comprising:
electronic elements arranged in a matrix;
vertical and horizontal drive circuits for driving the electronic elements; and
a timing signal generating apparatus which generates a plurality of timing signals and outputs the timing signals to the vertical and horizontal drive circuits based on a horizontal reference signal and a vertical reference signal,
the timing signal generating apparatus comprising: horizontal direction counter means for counting a clock number based on the horizontal reference signal; and
vertical direction counter means for counting a clock number based on the vertical reference signal,
the method comprising the steps of:
causing the horizontal direction counter means to start counting operation of a clock number upon input of the horizontal reference signal, and suspending or finishing counting operation of the horizontal direction counter means thereafter, the counting operation being suspended or finished until a next horizontal reference signal is supplied; and
causing the vertical direction counter means to start counting operation of a clock number upon input of the vertical reference signal, and suspending or finishing counting operation of the vertical direction counter means thereafter, the counting operation being suspended or finished until a next vertical reference signal is supplied.

32. A driving method for an electronic apparatus comprising:
electronic elements arranged in a matrix;
a drive circuit for driving the electronic elements; and
a timing signal generating apparatus which generates a plurality of timing signals and outputs the timing signals to the drive circuit based on a vertical reference signal and a clock signal,
the timing signal generating apparatus comprising:
counter means for counting a clock number of the clock signal based on the vertical reference signal; and
a signal generation circuit for generating a plurality of timing signals according to counter output of the counter means,
the method comprising the step of:
suspending or finishing counting operation of counter means during a period from input of an arbitrary reference signal to input of a next reference signal.

33. A driving method for an electronic apparatus comprising:
electronic elements arranged in an array;
a drive circuit for driving the electronic elements; and
a timing signal generating apparatus which generates a timing signal and outputs the timing signal to the drive circuit based on a reference signal,
the timing signal generating apparatus comprising:
counter means for carrying out counting operation based on the reference signal; and
a signal generation circuit for generating the timing signal according to counter output of the counter means,
the counter means is formed of a counter whose bit number is less than a bit number for expressing a binary number converted from a division result of 1 period of the reference signal by a period of the signal counted by the counter means,
the method comprising the step of:
outputting a control signal so that the signal generation circuit to stop referring to a signal number counted by the counter means at an end of counter of the counter means.
